(19) United States
(12) Patent Application Publication
(10) Pub. No.: US 2005/0222003 A1
(43) Pub. Date: Oct. 6, 2005

(54) Liquid bleaching compositions

(75) Inventors: Leo Gagliardi, Rome (IT); Stefano Resta, Rome (IT); Luca Sarcinelli, Rome (IT)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/096,171

(22) Filed: Mar. 31, 2005

(30) Foreign Application Priority Data
Apr. 5, 2004 (EP) 04447089.6

(51) Int. Cl. C11D 7/18

(52) U.S. Cl. 510/375

(57) ABSTRACT

The present invention relates to liquid bleach additive compositions comprising an imido-type peroxy acid and a source of protons.

### TECHNICAL FIELD

The present invention relates to a liquid bleach additive composition, which can be used to bleach fabrics in conjunction with a conventional particulate or liquid laundry detergent.

### BACKGROUND OF THE INVENTION

Commonly encountered liquid bleaching compositions suitable for the bleaching of stains on fabrics are based on halogen bleaches, especially hypochlorite bleaches, or peroxygen oxygen bleaches such as hydrogen peroxide.

Halogen bleaches are extremely effective bleaching agents, however they also present a number of drawbacks which can sometimes dissuade a consumer from choosing the halogen-containing product. For example halogen bleaches, especially chlorine bleaches, emit a pungent odor during and after use (e.g., on consumer hands and/or surfaces treated therewith) which some consumer find disagreeable.

Furthermore, it is known in the art that halogen bleach-containing compositions (typically hypochlorite) are relatively aggressive to fabrics and may cause damage when used in relatively high concentration and/or repeated usage. In particular the consumer may perceive damage to the fabric itself (e.g. loss of tensile strength) or damage to the color intensity of the fabric. While color and fabric damage may be minimized by employing milder peroxygen bleaches such as hydrogen peroxide, the bleach performance characteristics of such peroxygen bleaches are much less desirable than those of the halogen bleaching agents.

Therefore, liquid bleaching compositions comprising pre-formed peroxy carboxylic acid have been developed. It has been found that such bleaching compositions comprising pre-formed peroxy carboxylic acid show a good bleaching performance, when used in laundry applications, especially as so-called bleach additives, and are also safe to fabrics and/or colors. Indeed, peroxy carboxylic acids are known in the art, for example from EP-A-0 435 379. Furthermore, the use of such peroxy carboxylic acid to treat fabrics has been described in the art, e.g., in WO 00/27963, WO 00/27964, WO 00/27965, WO 00/27966, WO 00/27967, WO 00/27977 and WO 2002/12431.

It has been found that chemical stability of currently known peroxy carboxylic acid-based bleach additives was below expectations. In addition, preformed peroxy carboxylic acids represent a challenge to be handled at bleach additives manufacturing plants.

These difficulties have recently been overcome with the use of imido-type peroxy acids, which being solids are safer to be handled at manufacturing plants, and can also be stabilized into liquid bleach additive formulations by suspending them as solid particles. A specific class of imido-type peroxy acids are of imido-type peroxy alkanoic acids, especially phthalimido peroxy alkanoic acids, and in particular E-phthalimido peroxy hexanoic acid (PAP).

However, given their chemical structure, imido-type peroxy acids when present in bleach additives are not stable upon use at the pH of the wash liquor formed by conventional particulate laundry detergents. By “bleach additives” it is meant herein, a composition that is used in conjunction with, this means added to the washing machine together with, a conventional laundry detergent, in particular a particulate laundry detergent, in a laundry washing operation.

Usually, conventional particulate laundry detergents (like ARIEL powder) provide a pH in the wash above 9.5. The imido moiety of the peracid hydrolyzes quantitatively and irreversibly at such a pH (as described in REINHARDT, G. 1994b: Imidoperoxicarbonsäuren als potentielle Bleichmittel für die Waschmittelindustrie. SÖFW-Journal 120: 411-416). This leads to a hydrophilic molecule, which has been observed to provide bleaching performance of the wash liquor per-se in the washing machine (formed by the laundry detergent, the bleach additive and water) rather than stains on fabrics being washed in the washing machine. Indeed, currently known imido-type peroxy acids-based bleach additives failed to provide adequate bleaching performance on stains when used in combination with particulate detergents. This effect is not or at least to an insignificant extent observed in so-called pretreater bleaching compositions comprising imido-type peroxy acids, wherein the pretreater is applied onto the fabric prior to the washing or rinsing and left to act thereon for an effective amount of time.

It is thus an objective of the present invention to provide a liquid bleach additive comprising an imido-type peroxy acids, which delivers effective bleaching performance on stained fabrics, when used in conjunction with a conventional particulate laundry detergent.

It has now been found that the liquid bleach additives comprising an imido-type peroxy acid and a source of protons according to the present invention meets the above objective.

An advantage of the compositions of the present invention is that the liquid bleach additives herein are suitable for the bleaching of different types of fabrics including natural fabrics, (e.g., fabrics made of cotton, and linen), synthetic fabrics such as those made of polymeric fibres of synthetic origin (e.g., polyamide-elasthane) as well as those made of both natural and synthetic fibres. For example, the liquid bleach additives of the present invention herein may be used on synthetic fabrics despite a standing prejudice against using bleaches on synthetic fabrics, as evidenced by warnings on labels of clothes and commercially available bleaching compositions like hypochlorite-containing compositions.

Another advantage of the liquid bleach additives according to the present invention is that they can be used in a variety of conditions, i.e., in hard and soft water.

Yet another advantage of the compositions of the present invention is that they exhibit also effective stain removal performance on various stains including enzymatic stains and/or greasy stains.

### SUMMARY OF THE INVENTION

The present invention encompasses a liquid bleach additive composition having a viscosity of up to 5000 cps and/or comprising at least 50% by weight of the total composition of water, and additionally comprising an imido-type peroxy acid and a source of protons having at least one acidic moiety donating protons in water at a pH below 7.5, wherein said composition comprises at least 0.80 mmoles of protons available at pH below 7.5 per gram of composition.

The present invention further encompasses a kit comprising at least two compositions, wherein a first composition comprises an imido-type peroxy acid and optionally a source of protons having at least one acidic moiety donating protons in water at a pH below 7.5, and wherein a second composition comprises a source of protons having at least one acidic moiety donating protons in water at a pH below 7.5, wherein said compositions when combined comprise at least 0.80 mmoles of protons available at pH below 7.5 per gram of mixed compositions.

Furthermore, the present invention encompasses a process of treating fabrics which comprises the steps of forming an aqueous bath comprising water, a conventional laundry detergent, preferably a particulate laundry detergent, and a liquid bleach additive composition according to the present invention, and subsequently contacting said fabrics with said aqueous bath.

Moreover, the present invention encompasses a process of treating fabrics which comprises the steps of forming an aqueous bath comprising water, a conventional laundry detergent, preferably a particulate laundry detergent, and a liquid bleach additive composition formed by the at least two compositions of the kit according to the present invention, and subsequently contacting said fabrics with said aqueous bath.

Furthermore, the present invention encompasses the use of a source of protons having at least one acidic moiety donating protons in water at a pH below 7.5, in a liquid bleach additive composition comprising an imido-type peroxy acid, wherein said composition comprises at least 0.80 mmoles of protons available at pH below 7.5 per gram of composition to provide effective bleaching performance on stained fabrics, when used in conjunction with a conventional particulate laundry detergent.

### BRIEF DESCRIPTION OF THE DRAWINGS

FIGURE 1 is a plot showing the a titration curve of an average wash solution formed by a conventional particulate laundry detergent. Indeed, 110 grams of ARIEL® granular detergent were dissolved in 12 liters of water, which represents the recommended dosage of a granular detergent in a washing machine (under European washing conditions), and titrated with a composition comprising 10% of citric acid and 90% of water. The plot shows the pH of the wash solution versus the concentration of protons coming from the citric acid-containing composition.

### DETAILED DESCRIPTION OF THE INVENTION

The Liquid Bleach Additive Composition

The liquid bleaching compositions herein are so-called liquid bleach additive compositions suitable for use in conjunction with a conventional laundry detergent, and in particular with particulate laundry detergents, to treat (stained) fabrics. The terms “additive” or “through-the-wash (bleaching) composition” refer to compositions that are preferably employed in the specific process of treating, preferably bleaching, fabrics as encompassed by the present invention.

Indeed, additive compositions are added together with a conventional laundry detergent (preferably particulate laundry detergent) into a washing machine and are active in the same wash-cycle. By contrast, so-called ‘spotter’ or ‘pretreater’ compositions that are applied, mostly undiluted, onto fabrics prior to washing or rinsing the fabrics and left to act thereon for an effective amount of time. Furthermore, so-called ‘soakers’ or ‘rinse-added’ compositions are contacted, mostly in diluted form, with fabrics prior or during rinsing of fabrics with water.

The compositions according to the present invention are liquid compositions as opposed to a solid or a gas. The liquid bleach additive compositions have a viscosity of up to 5000 cps at 20 s⁻¹ and/or comprise at least 50% by weight of the total composition of water.

The liquid bleach additive compositions preferably have a viscosity of up to 5000 cps at 20 s⁻¹, more preferably from 5000 cps to 50 cps, yet more preferably from 2000 cps to 50 cps and most preferably from 1200 cps to 50 cps at 20 s⁻¹ and 20° C. when measured with a Carri-Med Rheometer model CSL² 100® (Supplied by TA Instruments) with a 4 cm conic spindle in stainless steal (linear increment from 0.1 to 100 sec⁻¹ in max. 8 minutes). The liquid bleach additive compositions are preferably not pasty or paste-like compositions.

Alternatively or additionally (preferably additionally), the liquid bleach additive compositions comprise at least 50%, preferably from 50% to 95%, more preferably 70% to 95%, even more preferably 75% to 95% by weight of the total composition of water.

Preferably, the pH of the compositions according to the present invention is from 0.1 to 6.5, more preferably from 0.5 to 5, even more preferably from 1 to 4. Formulating the compositions according to the present invention in the acidic pH range contributes to the chemical stability of the additive compositions according to the present invention. The pH of the composition is preferably below the pKa of acid corresponding to the imido-type peroxy acid used. It is believed that the acidic pH controls/limits the formation of highly reactive species which are instable in acidic medium upon storage, and thus contributes to the stability of the compositions for prolonged periods of storage.

The pH of the compositions is governed by the concentration and type of source of protons as discussed herein below.

The bleaching performance of the liquid bleach additive compositions herein may be evaluated by the following test methods on various types of bleachable stains:

A suitable test method for evaluating the bleaching performance on a soiled fabric under additive-conditions (also referred herein as “through-the-wash” conditions) is the following: A liquid bleach additive composition is used in the wash-cycle of a conventional washing machine. The liquid bleach additive composition is added together with a conventional particulate laundry detergent (such as DASH® powder, TIDE®, ARIEL tablets®, ARIEL® powder). The liquid bleach additive composition is dosed at 50 to 100 ml per wash load and the conventional laundry detergent is dosed at 110 grams per wash load for granules and 2 tabs per wash load for tablets (recommended dosages). In the washing machine the soiled fabrics are washed according to the standard procedure of the washing machine at a temperature of from 30° to 70° C. for 10 to 100 minutes and then rinsed. Reference composition(s) in the comparative test undergo the same treatment. Soiled fabrics/swatches with for example tea, coffee and the like may be commercially available from E.M.C. Co. Inc.

A visual grading may be used to assign difference in panel units (psu) in a range from 0 to 4, wherein 0 means no noticeable difference in bleaching performance between a liquid bleach additive composition according to the present invention and a reference composition and 4 means a noticeable difference in bleaching performance between a liquid bleach additive composition according to the present invention and a reference composition.

Imido-Type Peroxy Acids

The bleaching composition of the present invention comprises an imido-type peroxy acid. Said imido-type peroxy acid is preferably a solid, substantially water insoluble pre-formed imido-type peroxy acid. In a preferred embodiment of the present invention the imido-type peroxy acid has the general formula:
X—R—C(O)OOH
wherein R is a linear or branched, substituted or unsubstituted hydrocarbon chain having at least 1 carbon atom and X is a substituted imide, preferably a substituted imide wherein the imidic nitrogen forms a bond with R.

By a “substituted imide” it is meant herein an imide having a substitution on the nitrogen.

Preferably the imido-type peroxy acid is according to the general formula: 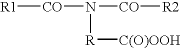
wherein R1 and R2 are independently linear or branched, substituted or unsubstituted hydrocarbon chains having at least 1 carbon atom, preferably aliphatic or aromatic hydrocarbon chains and may form a ring.

More particularly the R group preferably comprises from 2 to 24 carbon atoms. Alternatively, the R group may be a branched alkyl chain comprising one or more side chains which comprise substituent groups selected from the group consisting of aryl, halogen, ester, ether, amine, amide, substituted phthalic amino, imide, hydroxide, sulphide, sulphate, sulphonate, carboxylic, heterocyclic, nitrate, aldehyde, ketone or mixtures thereof.

In a preferred peracid the X group, according to the above general formula, is a phthalimido group. Thus, particularly preferred imido-type peroxy acids herein are those having general formula: 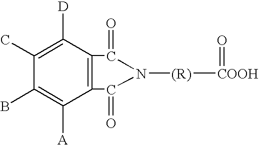
where R is C1-20 alkyl group and where A, B, C and D are independently either hydrogen or substituent groups individually selected from the group consisting of alkyl, hydroxyl, nitro, halogen, amine, ammonium, cyanide, carboxylic, sulphate, sulphonate, aldehydes or mixtures thereof.

In a preferred aspect of the present invention R is an alkyl group having from 3 to 12 carbon atoms, more preferably from 5 to 9 carbon atoms. Preferred substituent groups A, B, C and D are linear or branched alkyl groups having from 1 to 5 carbon atoms, but more preferably hydrogen.

In a preferred embodiment herein, said imido-type peroxy acid is an imido-type peroxy alkanoic acid, preferably a phthalimido peroxy alkanoic acid, even more preferably said imido-type peroxy acid is selected from the group consisting of: ε-phthalimido peroxy hexanoic acid (also known as Phthalimido peroxy caproic acid—PAP); phthalimido peroxy heptanoic acid; phthalimido peroxy octanoic acid; phthalimido peroxy nonanoic acid; and Phthalimido peroxy decanoic acid; and mixtures thereof and most preferably ε-phthalimido peroxy hexanoic acid (PAP).

Suitable phthalimido peroxy alkanoic acid have the general formula: 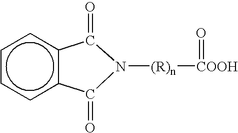
wherein R is selected from C1-4 alkyl and n is an integer of from 1 to 5.

PAP (ε-phthalimido peroxy hexanoic acid) as mentioned above is according to the above formula wherein R is CH₂ and n is 5.

PAP is preferably used as a substantially water-insoluble solid or wet-cake and is available from Ausimont under the trade name Eureco®.

Said imido-type peroxy acid may be present at a level in the composition of from 0.1% to 10% more preferably 0.1% to 5% and most preferably 1% to 5% by weight of the total composition. Alternatively the peracid may be present at a much higher level of for example 10% to 40%, more preferably from 15% to 30%, most preferably from 20% to 25% by weight of the total composition.

Source of Protons

The compositions herein comprise a source of protons having at least one acidic moiety donating protons in water at a pH below 7.5, wherein said composition comprises at least 0.80 mmoles of protons available at pH below 7.5 per gram of composition. The compositions herein may comprise a mixture of suitable sources of protons.

By a “source of protons” it is meant herein a species with Lewis/Bronsted acid behavior, i.e., a species which in water solution is capable of donating a proton or accepting an electron pair from another species.

By “mmoles of protons available at pH below 7.5 per gram of composition” it is meant herein the concentration of protons (in mmoles per gram of composition) available, this means either free protons or protons that may disassociate, at a pH below 7.5, which are capable of being delivered to (alkaline/base) species present in the wash solution and thereby reducing the pH in the wash liquor/solution formed by a conventional laundry detergent, preferably a conventional particulate laundry detergent.

The concentration (in mmoles per gram of composition) of available protons in a given composition is equivalent to the amount in mmoles of 1 M Sodium Hydroxide solution (1 mol of NaOH in 1 liter of demin. water) needed to bring the pH of 100 grams of the given composition up to a value of 7.5 and divided by 100.

For example, for 100 grams of a composition consisting of 5 grams citric acid and 95 grams of water (citric acid has mol. wt. of 192.12 and three acidic protons donated at a pH below 7.5), 79 mmoles of 1 M Sodium Hydroxide solution are required to bring the pH up to a value of 7.5. This means that said composition comprise a source of protons donating protons in water at a pH below 7.5 and wherein said source of protons is present at a concentration of 0.79 mmoles of protons available at pH below 7.5 per gram of composition.

Alternatively, for 100 grams of a composition consisting of 5 grams succinic acid and 95 grams of water (succinic acid has mol. wt. of 118.09 and two acidic protons donated at a pH below 7.5), 85 mmoles of 1 M Sodium Hydroxide solution are required to bring the pH up to a value of 7.5. This means that said composition comprise a source of protons donating protons in water at a pH below 7.5 and wherein said source of protons is present at a concentration of 0.85 mmoles of protons available at pH below 7.5 per gram of composition.

Furthermore, for 100 grams of a composition consisting of 4 grams succinic acid, 4 grams of citric acid and 92 grams of water, 130 mmoles of 1 M Sodium Hydroxide solution are required to bring the pH up to a value of 7.5. This means that said composition comprise a source of protons donating protons in water at a pH below 7.5 and wherein said source of protons is present at a concentration of 1.30 mmoles of protons available at pH below 7.5 per gram of composition.

The source of protons herein preferably is present at a concentration of at least 0.80, preferably at least 0.90, more preferably 1.0, even more preferably 1.1, yet more preferably 1.8, still more preferably 2.0 and most preferably 2.5 mmoles of protons available at pH below 7.5 per gram of composition.

In a preferred embodiment herein, the source of protons herein may be present at a concentration of up to 5, preferably up to 4.5, more preferably 4, even more preferably 3.5, yet more preferably 3.0, still more preferably 2.7 mmoles of protons available at pH below 7.5 per gram of composition.

Suitable sources of protons herein may be organic or inorganic. Suitable organic sources of protons herein are selected from the group consisting of: succinic acid, malonic acid, citric acid, glutaric acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mitures thereof. Suitable inorganic sources of protons herein are selected from the group consisting of: hydrogen-sulfuric acid, and dihydrogen-phosphoric acid, and mixtures thereof. Preferably said source of protons herein is selected from the group consisting of citric acid, succinic acid, malonic acid, glutaric acid, and adipic acid and mixtures thereof. More preferably said source of protons herein is selected from the group consisting of citric acid, succinic acid and malonic acid, and mixtures thereof. Most preferably said source of protons herein is citric acid.

Not suitable as sources of protons herein are for example sodium hydrogen carbonate, ammonium sulfate, mono ethanol-ammonium sulfate, percarboxylic acids (such as imido-type peroxy acids, like PAP), peracetic acid and diperpimelic acid. Indeed, without being limited by theory, the above listed un-suitable sources of protons fail to donate (or at least sufficiently donate) protons at a pH below 7.5.

In a highly preferred embodiment herein, said source of protons does not include the imido-type peroxy acid present in the compositions according to the present invention.

In a preferred embodiment herein, the composition herein comprises citric acid at concentration of at least 0.051 grams per gram of composition (resulting in a concentration of at least 0.80 mmoles of protons available at pH below 7.5 per gram of composition), preferably at least 0.083 grams per gram of composition (resulting in a concentration of at least 1.3 mmoles of protons available at pH below 7.5 per gram of composition) and more preferably at least 0.138 grams per gram of composition (resulting in a concentration of at least 2.2 mmoles of protons available at pH below 7.5 per gram of composition).

In another preferred embodiment herein, the composition herein comprises succinic acid at concentration of at least 0.047 grams per gram of composition (resulting in a concentration of at least 0.80 mmoles of protons available at pH below 7.5 per gram of composition), preferably at least 0.076 grams per gram of composition (resulting in a concentration of at least 1.3 mmoles of protons available at pH below 7.5 per gram of composition), and more preferably at least 0.127 grams per gram of composition (resulting in a concentration of at least 2.2 mmoles of protons available at pH below 7.5 per gram of composition).

In another preferred embodiment herein, the composition herein comprises malonic acid at concentration of at least 0.0416 grams per gram of composition (resulting in a concentration of at least 0.80 mmoles of protons available at pH below 7.5 per gram of composition), preferably at least 0.0675 grams per gram of composition (resulting in a concentration of at least 1.3 mmoles of protons available at pH below 7.5 per gram of composition), and more preferably at least 0.112 grams per gram of composition (resulting in a concentration of at least 2.2 mmoles of protons available at pH below 7.5 per gram of composition).

In another preferred embodiment herein, the composition herein comprises glutaric acid at concentration of at least 0.0528 grams per gram of composition (resulting in a concentration of at least 0.80 mmoles of protons available at pH below 7.5 per gram of composition), preferably at least 0.0859 grams per gram of composition (resulting in a concentration of at least 1.3 mmoles of protons available at pH below 7.5 per gram of composition), and more preferably at least 0.143 grams per gram of composition (resulting in a concentration of at least 2.2 mmoles of protons available at pH below 7.5 per gram of composition).

In another preferred embodiment herein, the composition herein comprises adipic acid at concentration of at least 0.0585 grams per gram of composition (resulting in a concentration of at least 0.80 mmoles of protons available at pH below 7.5 per gram of composition), preferably at least 0.0950 grams per gram of composition (resulting in a concentration of at least 1.3 mmoles of protons available at pH below 7.5 per gram of composition), and more preferably at least 0.158 grams per gram of composition (resulting in a concentration of at least 2.2 mmoles of protons available at pH below 7.5 per gram of composition).

In view of the above, the present invention also encompasses a liquid bleach additive composition having a viscosity of up to 5000 cps and/or comprising at least 50% by weight of the total composition of water, an imido-type peroxy acid and a source of protons, wherein said source of protons is selected from the group consisting of: citric acid present at a level of at least 5.1%; succinic acid present at a level of at least 4.7%; malonic acid present at a level of at least 4.2%; glutaric acid present at a level of at least 5.3%; and adipic acid present at a level of at least 5.9%; and mixtures thereof.

The above also applies to the kit according to the present invention as described herein.

The Applicant has found that by reducing the pH in the wash liquor formed by an conventional laundry detergent, preferably a conventional particulate laundry detergent (including powders, granules, pearls and tablets) and an imido-type peroxy acid-based, preferably PAP-based, bleach additive, the through-the-wash bleaching performance of the bleach additive can be significantly increased. Indeed, it has surprisingly been found that at a pH above 9, the imido-type peroxy acid molecule, preferably the PAP molecule, is irreversibly hydrolyzed to a hydrophilic molecule, which fails to be able to penetrate the hydrophobic fibres of fabrics and therefore also failing to be able to penetrate the bleachable stains present thereon. This leads to a limited bleaching performance on stained fabrics, whilst maintaining a good bleaching performance of the wash liquor, which is an aqueous solution and thus hydrophilic.

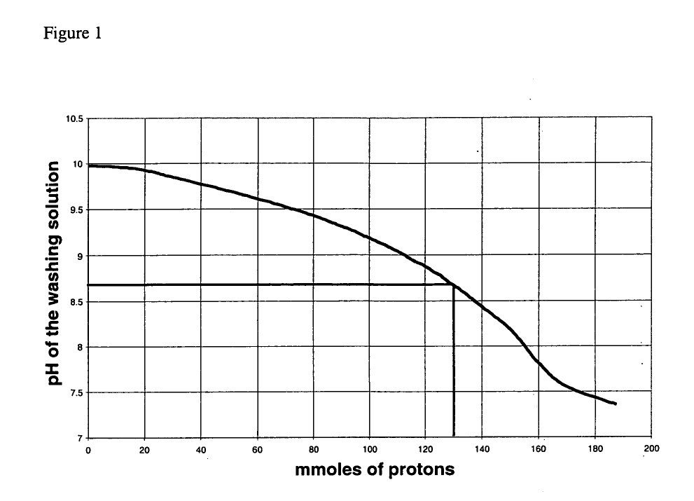

Indeed, the bleaching activity of imido-type peroxy acids is most optimal in a pH range of from 9.0 to 8.0 For example, the PAP bleaching activity is most optimal at a pH of 8.4. However, conventional laundry detergents and in particular conventional granular laundry detergent are heavily buffered compositions providing a wash liquor having a pH in the range of 9.8-10. Indeed, as shown in FIGURE 1 herein, a significant buffering can be observed for conventional granular laundry detergents.

As shown in FIGURE 1, in order to reduce the pH of the wash liquor/solution formed by conventional particulate laundry detergent to below 9, preferably to below 8.8, high amounts of protons are needed. Indeed, at least 80 mmoles of protons are needed to bring the pH of the wash solution to a pH below 9.5 and 130 mmoles of protons are needed to bring the pH of the wash solution to a pH below 8.8.

The protons have to be added in conjunction with the imido-type peroxy acid-containing liquid laundry bleach additive as described herein. Indeed, the bleach additive herein needs to contain high amounts of free acid (i.e., available protons) also referred to as reserve acidity. Such reserve acidity is provided by the source of protons herein.

For example, at a dosage of 162 grams of liquid bleach additive composition according to the present invention per wash-load 130 mmoles of available protons at pH below 7.5 (162 grams times 0.80 mmoles of protons available at pH below 7.5 per gram of composition) are available to off-set the buffering of the wash solution provided by the particulate laundry detergent.

It has been found that by adding a sufficient amount of reserve acidity into an imido-type peroxy acid-based bleach additive of the present invention, the bleaching performance of the additive in a through-the-wash bleach operation is significantly increased in comparison to bleach additives containing no or too little reserve acidity used in a similar operation.

Optional Ingredients

The compositions herein may further comprise a variety of other optional ingredients such as polymeric systems, surfactants, chelating agents, radical scavengers, antioxidants, stabilisers, builders, soil suspending polymer, polymeric soil release agents, dye transfer inhibitor, solvents, suds controlling agents, suds booster, brighteners, perfumes, pigments, dyes and the like.

Polymeric System

The composition of the present invention may comprise a gum-type polymer preferably selected from the group consisting of polysaccharide hydrocolloids, xanthan gum, guar gum, succinoglucan gum, cellulose, derivatives of any of the above and mixtures thereof. In a preferred aspect of the present invention the gum-type polymer is a succinoglucan gum or a derivative thereof.

The gum-type polymer is preferably present at a level of from 0.01% to 10%, more preferably from 0.05% to 3%, even more preferably from 0.1% to 1.0%.

Surfactants

The compositions of the present invention may comprise a surfactant or a mixture thereof including nonionic surfactants, anionic surfactants, cationic surfactants, zwitterionic surfactants and/or amphoteric surfactants.

Typically, the compositions according to the present invention may comprise up to 10% by weight of the total composition of a surfactant or a mixture thereof, preferably up to 5% and more preferably up to 2%.

Hydrotropes

The compositions of the present invention may comprise a hydrotrope or a mixture thereof. Hydrotropes are a special class of compounds that are efficient solubilisers, because they can self-associate in aqueous medium influencing the formation of micelles and microemulsions.

Suitable hydrotropes for use herein may include alkylbenzene sulphonates based on toluene, xylene and cumene, polyhydroxy benzene, sodium salts of lower alkanols and derivatives of aromatic acids are generally considered to be effective hydrotropes.

Typically, the compositions according to the present invention may comprise up to 5% by weight of the total composition of a hydrotrope or a mixture thereof, preferably up to 1% and more preferably up to 1%.

Chelating Agents

The compositions of the present invention may comprise a chelating agent as a preferred optional ingredient. Suitable chelating agents may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof.

The presence of chelating agents contribute to further enhance the chemical stability of the compositions. A chelating agent may be also desired in the compositions of the present invention as it allows to increase the ionic strength of the compositions herein and thus their stain removal and bleaching performance on various surfaces.

Suitable phosphonate chelating agents for use herein may include alkali metal ethane 1-hydroxy diphosphonates (HEDP), alkylene poly(alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula: 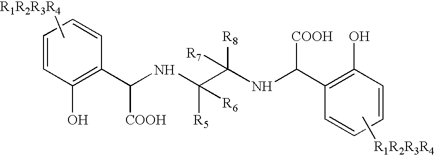
wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the compositions according to the present invention comprise up to 5% by weight of the total composition of a chelating agent, or mixtures thereof, preferably from 0.01% to 1.5% by weight and more preferably from 0.01% to 0.5%.

Radical Scavengers

The compositions of the present invention may comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, preferably 100 mmoles, more preferably 130 mmoles, still more preferably 180 mmoles, most preferably 210 mmoles of protons available at pH below 7.5 per wash-load. Indeed, sufficient amount of said liquid bleach additive composition is added to provide the above amounts of protons available at pH below 7.5.

Typically, the liquid bleach additive compositions according to the present invention are dosed at minimum 50 grams per wash-load, preferably of from 55 grams to 170 grams, more preferably 60 grams to 110 grams. The dosage of the liquid bleach additive composition herein depends on the level of protons available at a pH below 7.5 per gram of composition. Indeed, compositions having levels of protons available at a pH below 7.5 per gram of composition at the minimum required level herein (0.8 mmoles per gram of composition) require a higher dosage (162.5 grams to, e.g., donate 130 mmoles of protons available at pH below 7.5 per wash-load). Compositions having levels of protons available at a pH below 7.5 per gram of composition above the minimum required level herein (e.g., 1.3 mmoles per gram of composition) require a lower dosage (100 grams to, e.g., donate 130 mmoles of protons available at pH below 7.5 per wash-load).

Moreover, the present invention encompasses a process of treating fabrics which comprises the steps of forming an aqueous bath comprising water, a conventional laundry detergent, preferably a granular laundry detergent, and a liquid bleach additive composition formed by the at least two compositions of the kit according to the present invention, and subsequently contacting said fabrics with said aqueous bath.

In the specific embodiment herein, wherein the liquid bleach additive composition is formed by the at least two compositions of the kit according to the present invention, the mixing of the at least two compositions of said kit may occur prior to forming said aqueous bath (i.e., before adding it to the washing machine) and/or at the same time as forming said aqueous bath (i.e., in the washing machine).

In a highly preferred embodiment herein, the combination of compositions in the kit according to the present invention are dosed herein to provide at least 80 mmoles, preferably 100 mmoles, more preferably 130 mmoles, still more preferably 180 mmoles, 1,1,3-tris(2-methyl-4-hydroxy-5-t-butylphenyl)butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers when used, are typically present herein in amounts up to 10% by weight of the total composition and preferably up to 0.5% by weight.

The presence of radical scavengers may contribute to the chemical stability of the bleaching compositions of the present invention as well as to the safety profile of the compositions of the present invention.

Stabilisers

The compositions of the present invention may further a stabilizer. Examples of inorganic stabilizers include sodium stannate and various alkali metal phosphates such as the well-known sodium tripolyphosphates, sodium pyrophosphate and sodium orthophosphate.

Soil Suspending Polymer

The compositions according to the present invention may further comprise a soil suspending polyamine polymer or mixtures thereof, as optional ingredient. Any soil suspending polyamine polymer known to those skilled in the art may be used herein. Particularly suitable polyamine polymers for use herein are polyalkoxylated polyamines.

Typically, the compositions comprise up to 10% by weight of the total composition of such a soil suspending polyamine polymer or mixtures thereof, preferably from 0.1% to 5% and more preferably from 0.3% to 2%.

The compositions herein may also comprise other polymeric soil release agents known to those skilled in the art. Such polymeric soil release agents are characterised by having both hydrophilic segments, to hydrophilize the surface of hydrophobic fibres, such as polyester and nylon, and hydrophobic segments, to deposit upon hydrophobic fibres and remain adhered thereto through completion of washing and rinsing cycles and, thus, serve as an anchor for the hydrophilic segments. This can enable stains occurring subsequent to treatment with the soil release agent to be more easily cleaned in later washing procedures.

If utilized, soil release agents will generally comprise from 0.01% to 10.0%, by weight, of the detergent compositions herein, typically from 0.1% to 5%, preferably from 0.2% to 3.0%.

Brightener

Any optical brighteners, fluorescent whitening agents or other brightening or whitening agents known in the art can be incorporated in the instant compositions when they are designed for fabric treatment or laundering, at levels typically from about 0.05% to about 1.2%, by weight, of the detergent compositions herein.

Minor Ingredients

The composition described herein may also comprise minor ingredients such as pigment or dyes, suds controlling agents, dye transfer inhibitors, suds boosters and perfumes.

Processes of Treating Fabrics

The present invention encompasses a process of treating fabrics which comprises the steps of forming an aqueous bath comprising water, a conventional laundry detergent, preferably a granular laundry detergent, and a liquid bleach additive composition according to the present invention, and subsequently contacting said fabrics with said aqueous bath.

In a highly preferred embodiment herein, the liquid bleach additive compositions according to the present invention are dosed herein to provide at least 80 mmoles, most preferably 210 mmoles of protons available at pH below 7.5 per wash-load. Typically, the combination of compositions in the kit according to the present invention are dosed at minimum 50 grams per wash-load, preferably of from 55 grams to 170 grams, more preferably 60 grams to 110 grams. As outlined above, the dosage of the liquid bleach additive composition herein depends on the level of protons available at a pH below 7.5 per gram of composition.

The processes of treating, preferably bleaching, fabrics according to the present invention delivers effective whiteness performance as well as effective stain removal performance.

The process of treating fabrics herein comprises the steps of forming an aqueous bath comprising water, a conventional laundry detergent and a liquid bleach additive composition, as described herein, subsequently contacting said fabrics with said aqueous bath.

By “conventional laundry detergent” it is meant herein, a laundry detergent composition currently available on the market. Preferably, said conventional laundry detergent comprises at least one surfactant. Said laundry detergent compositions may be formulated as particulates (including powders, pearls, granules, tablets and the like), liquids (liquids, gels, and the like) as well as detergent forms based on water-soluble or water-permeable pouches comprising liquids and/or particulates (such as liquid-tabs). Suitable particulate laundry detergent compositions are for example DASH powder®, ARIEL tablets®, ARIEL powder® and other products sold under the trade names ARIEL® or TIDE®.

In a preferred embodiment herein, the conventional laundry detergent is a conventional particulate laundry detergent more preferably a conventional powder, pearl, granule or tablet laundry detergent.

In a preferred embodiment according to the present invention, the conventional laundry detergent as described herein and, the liquid bleach additive composition herein are dissolved or dispersed, preferably substantially dissolved or dispersed, in the aqueous bath formed in the process according to the present invention. By “substantially dissolved or dispersed” it is meant herein, that at least 50%, preferably at least 80%, more preferably at least 90%, even more preferably at least 95%, still more preferably at least 98%, and most preferably at least 99%, of said conventional laundry detergent and/or said liquid bleach additive composition are dissolved or dispersed in the aqueous bath formed in the process according to the present invention.

The liquid bleach additive composition and the conventional detergent composition may be delivered into the washing machine either by charging the dispenser drawer of the washing machine with one or both of the detergents or by directly charging the drum of the washing machine with one or both of the detergents. More preferably the liquid bleach additive composition is directly placed into the drum of the washing machine, preferably using a dosing device, such as a dosing ball (such as the Vizirette®). Even more preferably the liquid bleach additive composition and the conventional detergent composition are both placed into the drum of the washing machine, preferably using suitable dosing devices such as dosing balls, dosing nets etc. The liquid bleach additive composition is preferably delivered to the main wash cycle of the washing machine before, but more preferably at the same time as the conventional detergent composition.

During the processes according to the present invention the liquid bleach additive compositions herein is typically used in diluted form. By “in diluted form”, it is meant herein that the liquid bleach additive compositions according to the present invention may be diluted by the user, preferably with water. The dilution occurs in a washing machine. Said compositions can be diluted up to 500 times, preferably from 5 to 200 times and more preferably from 10 to 80 times.

Packaging Form of the Liquid Compositions:

Depending on the end-use envisioned, the compositions herein can be packaged in a variety of containers including conventional bottles.

The present invention further encompasses as a separate embodiment, a kit comprising at least two compositions, wherein a first composition comprises an imido-type peroxy acid and optionally a source of protons having at least one acidic moiety donating protons in water at a pH below 7.5, and wherein a second composition comprises a source of protons having at least one acidic moiety donating protons in water at a pH below 7.5, wherein said compositions when combined comprise at least 0.80 mmoles of protons available at pH below 7.5 per gram of mixed compositions.

By “combined” or “mixed” it is meant the combination of the compositions present in the kit at a ratio according to the use instructions or implied use conditions intended for the kit. For dual compartment containers this may be a 1:1 mix-ratio. However, other mix ratios are also envisage herein.

The concentration (in mmoles per gram of composition) of available protons in a given mixture of compositions is equivalent to the amount in mmoles of 1 M Sodium Hydroxide solution (NaOH) needed to bring the pH of 100 grams of the given composition up to a value of 7.5 and divided by 100, as discussed herein above.

In case the kit according to the present invention comprises at least one solid composition, the concentration of available protons is assessed by dissolving 100 grams of combined composition in 100 g of demin. Water.

In this embodiment of the present invention the at least two compositions herein may be packaged in a two compartment container or in two separate containers. Furthermore, one or more of said at least two compositions may be packaged in a water-soluble container, such as a water-soluble pouch (preferably made of polyvinyl-alcohol or -acetate pouch).

The compositions in the kit according to the present invention may independently be solid or liquid compositions. The compositions and optional ingredients may be similar to the ones discussed herein above.

In a highly preferred embodiment, at least one of the compositions present in said kit is a liquid composition having similar properties as described herein above. Even more preferably, the kit comprises at least two liquid compositions, more preferably two compositions, packed in a two compartment container.

The invention is further illustrated by the following examples.

### EXAMPLES

The following examples will further illustrate the present invention. The compositions are made by combining the listed ingredients in the listed proportions (weight % unless otherwise specified). Furthermore, the compositions comprise water and minors up to 100%. The following Examples are meant to exemplify compositions according to the present invention but are not necessarily used to limit or otherwise define the scope of the present invention.

| | Compositions (% weight) | | | | |
|---|---|---|---|---|---|
| | I | II | III | IV | V |
| PAP | 3.0 | 2.0 | 4.0 | 1.0 | 5.0 |
| HEDP | 0.2 | 0.1 | 0.2 | 0.1 | 0.2 |
| Citric acid | 8.3 | 0.0 | 0.0 | 9.2 | 4.0 |
| Succinic acid | 0.0 | 7.6 | 0.0 | 0.0 | 5.0 |
| Malonic acid | 0.0 | 0.0 | 6.8 | 0.0 | 0.0 |
| Glutaric acid | 0.0 | 0.0 | 0.0 | 0.0 | 0.0 |
| Adipic acid | 0.0 | 0.0 | 0.0 | 0.0 | 0.0 |
| Witconate NAS 8 ® | 0.5 | 1.0 | 0.0 | 1.0 | 0.0 |
| NaXS | 0.0 | 0.0 | 0.5 | 0.5 | 0.5 |
| pH (trimmed with NaOH) | 1.9 | 2.5 | 2.5 | 2.5 | 1.9 |
| mmoles of protons | 1.4 | 1.4 | 1.4 | 1.4 | 1.5 |
| per gram of composition | | | | | |
| | Compositions (% weight) | | | | |
| | VI | VII | VIII | IX | X |
| PAP | 3.0 | 5.0 | 4.0 | 1.0 | 3.0 |
| HEDP | 0.2 | 0.2 | 0.2 | 0.1 | 0.2 |
| Citric acid | 5.1 | 13.8 | 0.0 | 8.0 | 11.2 |
| Succinic acid | 0.0 | 0.0 | 12.8 | 5.0 | 0.0 |
| Malonic acid | 0.0 | 0.0 | 0.0 | 0.0 | 0.0 |
| Glutaric acid | 0.0 | 0.0 | 0.0 | 0.0 | 0.0 |
| Adipic acid | 0.0 | 0.0 | 0.0 | 0.0 | 0.0 |
| Witconate NAS 8 ® | 0.5 | 0.0 | 0.0 | 1.0 | 0.0 |
| NaXS | 0.0 | 0.5 | 0.5 | 0.5 | 0.5 |
| pH (trimmed with NaOH) | 2.0 | 1.5 | 2.1 | 1.9 | 3.0 |
| mmoles of protons | 0.8 | 2.2 | 2.2 | 2.4 | 1.4 |
| per gram of composition | | | | | |
| | Compositions (% weight) | | | | |
| | XI | XII | XIII | XIV | XV |
| PAP | 3.0 | 2.0 | 1.0 | 2.0 | 2.0 |
| HEDP | 0.2 | 0.2 | 0.2 | 0.1 | 0.2 |
| Citric acid | 8.3 | 8.3 | 8.3 | 0.0 | 0.0 |
| Succinic acid | 0.0 | 0.0 | 0.0 | 0.0 | 0.0 |
| Malonic acid | 0.0 | 0.0 | 0.0 | 0.0 | 0.0 |
| Glutaric acid | 0.0 | 0.0 | 0.0 | 0.0 | 8.6 |
| Adipic acid | 0.0 | 0.0 | 0.0 | 9.5 | 0.0 |
| Witconate NAS 8 ® | 0.0 | 0.0 | 0.0 | 0.0 | 0.5 |
| NaXS | 0.5 | 0.5 | 0.5 | 0.5 | 0.0 |
| pH (trimmed with NaOH) | 1.9 | 1.9 | 1.9 | 2.9 | 3.0 |

Witkonate NAS 8® is an alkyl sulphonate available from Witco AS. BHT is di-tert butyl hydroxy toluene.
HEDP is ethane 1-hydroxy diphosphonate commercially available from Monsanto under the DEQUEST® series.
PAP is phthalimido peroxy hexanoic acid available from Ausimont under the tradename Eureco®.
NaXS is sodium xylene sulfonate, available from Rhodia under the trade name of Eltesol SX 33®.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A liquid bleach additive composition having a viscosity of up to about 5000 cps and/or comprising at least about 50% by weight of the total composition of water, and additionally comprising an imido-type peroxy acid and a source of protons having at least one acidic moiety donating protons in water at a pH below about 7.5, wherein said composition comprises at least about 0.80 mmoles of protons available at pH below about 7.5 per gram of composition.

2. A liquid bleach additive composition according to claim 1, wherein said imido-type peroxy acid is a solid, substantially water insoluble pre-formed imido-type peroxy acid.

3. A liquid bleach additive composition according to claim 1, wherein said imido-type peroxy acid has the general formula: 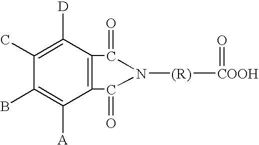
wherein R is about C1-20 alkyl group and where A, B, C and D are independently either hydrogen or substituent groups individually selected from the group consisting of alkyl, hydroxyl, nitro, halogen, amine, ammonium, cyanide, carboxylic, sulphate, sulphonate, aldehydes or mixtures thereof.

4. A liquid bleach additive composition according to claim 1, wherein said imido-type peroxy acid has general formula: 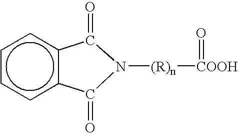
wherein R is about C₁₋₄ alkyl and n is an integer of from about 1 to about 5.

5. A liquid bleach additive composition according to claim 1, wherein said imido-type peroxy acid is an imido-type peroxy alkanoic acid.

6. A liquid bleach additive composition according to claim 1, wherein said imido-type peroxy acid is selected from the group consisting of: ε-phthalimido peroxy hexanoic acid; phthalimido peroxy heptanoic acid; phthalimido peroxy octanoic acid; phthalimido peroxy nonanoic acid; and Phthalimido peroxy decanoic acid; and mixtures thereof.

7. A liquid bleach additive composition having a viscosity of up to about 5000 cps and/or comprising at least about 50% by weight of the total composition of water, and additionally comprising ε-phthalimido peroxy hexanoic acid and a source of protons having at least one acidic moiety donating protons in water at a pH below about 7.5, wherein said composition comprises at least about 0.80 mmoles of protons available at pH below about 7.5 per gram of composition.

8. A liquid bleach additive composition according to claim 1, wherein said composition comprises of from about 0.1% to about 10% by weight of the total composition of said imido-type peroxy acid.

9. A liquid bleach additive composition according to claim 1, wherein said composition comprises of from about 10% to about 40% by weight of the total composition of said imido-type peroxy acid.

10. A liquid bleach additive composition according to claim 1, wherein said source of protons is present at a concentration of at least about 0.90 mmoles of protons available at pH below about 7.5 per gram of composition.

11. A liquid bleach additive composition according to claim 1, wherein said source of protons is present at a concentration of up to about 5 mmoles of protons available at pH below about 7.5 per gram of composition.

12. A liquid bleach additive composition according to claim 1, wherein said source of protons is an organic source of protons selected from the group consisting of: succinic acid, malonic acid, citric acid, glutaric acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mixtures thereof.

13. A liquid bleach additive composition according to claim 1, wherein said source of protons is an inorganic source of protons selected from the group consisting of hydrogen-sulfuric acid, and dihydrogen-phosphoric acid, and mixtures thereof.

14. A liquid bleach additive composition according to claim 1, wherein said source of protons is selected from the group consisting of citric acid, succinic acid, malonic acid, glutaric acid, and adipic acid and mixtures thereof.

15. A liquid bleach additive composition having a viscosity of up to about 5000 cps and/or comprising at least about 50% by weight of the total composition of water, and additionally comprising ε-phthalimido peroxy hexanoic acid and a source of protons having at least one acidic moiety donating protons in water at a pH below about 7.5, wherein said composition comprises at least about 0.80 mmoles of protons available at pH below about 7.5 per gram of composition, and wherein said source of protons is selected from the group consisting of citric acid, succinic acid, malonic acid, glutaric acid, and adipic acid and mixtures thereof.

16. A process of treating fabrics which comprises the steps of forming an aqueous bath comprising water, a conventional laundry detergent, preferably a granular laundry detergent, and a liquid bleach additive composition, and subsequently contacting said fabrics with said aqueous bath, wherein said liquid bleach additive composition has a viscosity of up to about 5000 cps and/or comprises at least about 50% by weight of the total composition of water, and additionally comprises an imido-type peroxy acid and a source of protons having at least one acidic moiety donating protons in water at a pH below about 7.5, and wherein said composition comprises at least about 0.80 mmoles of protons available at pH below about 7.5 per gram of composition.

17. A process of treating fabrics according to claim 16, wherein sufficient amount of said liquid bleach additive composition is added to provide at least about 80 mmoles of protons available at pH below about 7.5.

18. A liquid bleach additive composition having a viscosity of up to about 5000 cps and/or comprising at least about 50% by weight of the total composition of water, and additionally comprising an imido-type peroxy acid and a source of protons, wherein said source of protons is selected from the group consisting of: citric acid present at a level of at least about 5.1%; succinic acid present at a level of at least about 4.7%; malonic acid present at a level of at least about 4.2%; glutaric acid present at a level of at least about 5.3%; and adipic acid present at a level of at least about 5.9%; and mixtures thereof.

19. A liquid bleach additive composition having a viscosity of up to about 5000 cps and/or comprising at least about 50% by weight of the total composition of water, and additionally comprising ε-phthalimido peroxy hexanoic acid and a source of protons, wherein said source of protons is selected from the group consisting of: citric acid present at a level of at least about 5.1%; succinic acid present at a level of at least about 4.7%; malonic acid present at a level of at least about 4.2%; glutaric acid present at a level of at least about 5.3%; and adipic acid present at a level of at least about 5.9%; and mixtures thereof.

20. A kit comprising at least two compositions, wherein a first composition comprises an imido-type peroxy acid and optionally a source of protons having at least one acidic moiety donating protons in water at a pH below about 7.5, and wherein a second composition comprises a source of protons having at least one acidic moiety donating protons in water at a pH below about 7.5, wherein said compositions when combined comprise at least about 0.80 mmoles of protons available at pH below about 7.5 per gram of mixed compositions.

21. A kit comprising at least two compositions, wherein a first composition comprises ε-phthalimido peroxy hexanoic acid and optionally a source of protons having at least one acidic moiety donating protons in water at a pH below about 7.5, and wherein a second composition comprises a source of protons having at least one acidic moiety donating protons in water at a pH below about 7.5, wherein said compositions when combined comprise at least about 0.80 mmoles of protons available at pH below about 7.5 per gram of mixed compositions.

22. A process of treating fabrics which comprises the steps of forming an aqueous bath comprising water, a conventional laundry detergent, preferably a granular laundry detergent, and a liquid bleach additive composition formed by the at least two compositions of the kit according to claim 20, and subsequently contacting said fabrics with said aqueous bath.

23. A method of providing effective bleaching performance on stained fabrics to a liquid bleach additive composition comprising an imido-type peroxy acids when used in conjunction with a conventional particulate laundry detergent by adding to said composition a source of protons having at least one acidic moiety donating protons in water at a pH below about 7.5 in an amount so that said composition comprises at least about 0.80 mmoles of protons available at pH below about 7.5 per gram of composition.
